(19) United States
(12) Patent Application Publication
(10) Pub. No.: US 2009/0040886 A1
(43) Pub. Date: Feb. 12, 2009

(54) Disk playback apparatus and method

(76) Inventor: Koji Kishimoto, Osaka (JP)

Correspondence Address: MCDERMOTT WILL & EMERY LLP, 600 13TH STREET, NW, WASHINGTON, DC, 20005-3096, US

(21) Appl. No.: 10/584,690

(22) PCT Filed: Feb. 18, 2005
(86) PCT No.: PCT/JP2005/002573

§ 371 Date: Jun. 28, 2006

(30) Foreign Application Priority Data
Feb. 18, 2004 (JP) 2004-041423

(51) Int. Cl. G11B 21/08

(52) U.S. Cl. 369/30.04; G9B/21.012

(57) ABSTRACT

To provide a disk playback apparatus and a playback method which, upon issuance of a request for sound-playback from an arbitrary position on a disk, can playback sound instantly without disposing complicated switching means, the present invention provides a disk playback apparatus having access means for accessing a disk, and access-control means for controlling the access means to an arbitrary position on the disk, including storage means divided into a first area for storing at least one set of audio data having a specific length for at least one track, and a second area for storing remaining audio data for the one track; write means which accesses the disk, thereby writing the audio data—having the specific length and whose start point is an arbitrary position on the one track—into the first area, and writing the remaining audio data into the second area during playback of the audio data having the specific length; and read means for reading the audio data having the specific length and the remaining audio data continuously.

### FIELD OF THE INVENTION

The present invention relates to a disk playback apparatus and a method for playing back a disk.

### BACKGROUND

Hereinbelow, a technique for playing back audio data recorded in a conventional optical disk will be described. FIG. 1 is a block structural diagram of a conventional optical disk playback apparatus.

In FIG. 1, a laser beam having impinged on an optical disk 1 is reflected from the optical disk 1, and arrives an optical pickup 3 via a lens 2. The laser beam having arrived is converted into an electrical signal by the optical pickup 3; and the converted electrical signal is amplified by a head amplifier 4, to thus be synthesized into a focus error signal and a tracking error signal.

The focus error signal and the tracking error signal are input to a servo-and-signal processing LSI 5. The servo-and-signal processing LSI 5 performs focusing servo processing in accordance with the focus error signal. A control signal obtained through this processing is amplified by a driver 6, and transmitted to a focusing motor, thereby controlling movement of the lens 2 by way of the focusing motor.

In addition, the servo-and-signal processing LSI 5 performs tracking servo processing and traverse servo processing in accordance with the tracking error signal. Control signals obtained through the respective processing operations are amplified by the driver 6 and transmitted to the tracking motor and a traverse motor, respectively, whereupon tracking control and traverse control are performed. Finally, the servo-and-signal processing LSI 5 performs CLV (constant linear velocity) servo processing in accordance with a synchronizing signal. A control signal obtained through the processing is transmitted to a spindle motor 7 by way of the driver 6, thereby controlling the rotation speed of the spindle motor 7.

A signal processing circuit 51 of the servo-and-signal processing LSI 5 demodulates signals written in the optical disk 1. When the optical disk 1 is, e.g., a CD-DA (compact disk-digital audio) disk, audio data, such as music data, are stored in a memory 8 in a format where recording is performed in a logical record LR unit of four bytes as illustrated in FIG. 2. Accordingly, only audio data (music data, or the like) are stored in the memory 8. The audio data stored in the memory 8 are subjected to DA (digital-analog) conversion by a DF-DAC (digital filter-digital analog converter) circuit 52, and output as analog sound.

In addition, when the optical disk 1 is a CD-ROM disk, audio data, such as music data, are stored in a DATA section of the memory 8 in a format constituted of SYNC (synchronization data), HEADER (address data), DATA (actual data), EDC (error detection data), and ECC (error correction data) as illustrated in FIG. 3. Accordingly, only the DATA section in the format illustrated in FIG. 3 is decoded by a decoder 9; converted from digital to analog by the DF-DAC circuit 52; and output as analog sound.

The above-described conventional optical disk playback apparatus performs processing as follows for performing head search for a head of a specific music track among music tracks recorded in the optical disk. First, a user requests a head search of a specific music track through key operation, or the like. At this time, first, a read pointer and a write pointer in a memory are initialized as shown in FIG. 16 (step S1601). A difference between a current position of the optical pickup 3 and a target position where data pertaining to the head of the specific music track are recorded on the optical disk 1 is calculated (step S1602). When the difference between the current position and the target position is not “0” and the current position is not located several blocks frontward of the target position (step S1603), the difference between the two positions is converted into and set to the number of blocks by which the optical pickup 3 is caused to jump to the target position (S1604). Then, the optical pickup 3 is caused to jump by the number of blocks having been set (step S1605), and a determination is made as to whether or not the jump operation has been completed (step S1606).

When the jump operation is determined to have been completed, a difference between a current position of the optical pickup 3 and the target position on the optical disk 1 is calculated again (step S1602). When the difference between the current position and the target position is “0” or when the current position is several blocks frontward of the target position (step S1603), SUBQ data pertaining to the target position are confirmed, audio data recorded in the optical disk 1 are read by the optical pickup 3, and writing into the memory 8 is started (S1607). Subsequently, when a predetermined amount of data is stored in the memory 8, the audio data written in the memory 8 are output, and playback from the head of the specific music track is started (step S1608).

However, the above-mentioned optical disk playback apparatus having the conventional structure has problems that jump operation of the optical pickup to the target position is required for every issuance of a request for a head search of a specific music track; and, furthermore, that, when the current position and the target position are separated, the jump operation consumes time, thereby often involving a delay from issuance of the request for the head search until output of the thus-head-searched audio data.

To solve the problems, as described in JP-A-2002-100123 and JP-A-176174, there have been disclosed techniques for shortening time required for a head search by means of efficiently storing audio data recorded in an optical disk into a memory disposed in an optical disk playback apparatus, and reading the audio data from the memory.

However, a head search of a music track according to JP-A-2002-100123 involves a problem that, although audio data for use in head search among a plurality of music tracks are stored in a memory, when a request for a head search of a specific track is issued, audio data other than those for use in the head search of the specific track are erased. Accordingly, upon issuance of a request for a head search of a music track whose audio data for use in head search have been erased, audio data for use in head search must be stored in the memory again, thereby consuming time until output of audio data.

In addition, in a head search of a music track according to JP-A-7-176174, there is required means for switching between sound-playback in accordance with audio data for use in a track stored in a memory, and sound-playback in accordance with audio data extracted from an optical disk by an optical pickup. Accordingly, the optical disk playback apparatus is complicated in terms of disposition of the switching means; and in practice, performing switching of sound-playback while maintaining a high audio quality has encountered difficulty.

In addition, since each of the techniques described in JP-A-2002-100123 and JP-A-7-176174 is limited to a head search of a music track, employment of the same in a case where audio data at an arbitrary position are to be output, such as in AB repeat mode, has encountered difficulty.

### DISCLOSURE OF THE INVENTION

For the purpose of solving the above problem, the present invention aims at providing a disk playback apparatus and a playback method which, upon issuance of a request for sound-playback from an arbitrary position on a disk, can playback sound instantly without disposing complicated switching means.

The present invention provides a disk playback apparatus having access means for accessing a disk, and access-control means for controlling the access means to an arbitrary position on the disk, characterized by including:

storage means divided into a first area for storing at least one set of audio data having a specific length for at least one track, and a second area for storing remaining audio data for the one track;

write means which accesses the disk, thereby writing the audio data—having the specific length and whose start point is an arbitrary position on the one track—into the first area, and writing the remaining audio data into the second area during playback of the audio data having the specific length; and

read means for reading the audio data having the specific length and the remaining audio data continuously.

In addition, the invention provides a disk playback method for a disk playback apparatus which accesses a disk, thereby storing into a first area audio data—having a specific length and whose start point is an arbitrary position on the one track—in advance, and playing back the audio data stored in the storage means, characterized by including steps of:

reading the audio data having the specific length and whose start point is the arbitrary position of one track;

accessing the disk during reading of the audio data—having the specific length and whose start point is the arbitrary position on the one track—thereby starting writing of the remaining audio data on the one track into a second area of the storage means; and

reading the remaining audio data continuously subsequent to the audio data having the specific length.

According to the configuration, audio data having the specific length on the one track are played back instantly, and, furthermore, during playback of the same, the access means accesses the disk, thereby starting writing of the remaining audio data for the one track into the second area; accordingly, time which would be consumed from issuance of a request for playback to access to the disk is obviated.

The invention provides a disk playback apparatus, characterized by further including transfer means for transferring audio data from a read point of the second area to the first area, and characterized in that

the write means writes, during playback of the remaining audio data,
the audio data from the read point having been transferred by the transfer means into the first area, and
the remaining audio data on the one track of the audio data from the read point having been written into the first area; and

the read means reads audio data from the read point having been written into the first area and the remaining audio data on the one track of the audio data from the read point having been written into the second area continuously.

In addition, the invention provides a disk playback method characterized by further including steps of:

during reading of the remaining audio data, transferring audio data from the read point in the second area;

writing the audio data from the read point having been transferred into the first area;

reading the audio data from the read point having been written into the first area;

during reading of the audio data from the read point, accessing the disk, thereby starting writing, into the second area, of the remaining audio data on the one track of the audio data from the read point having been written into the first area; and

reading the remaining audio data on the one track of the audio data from the read point in the second area continuously subsequent to the audio data from the read point in the first area.

According to the configuration, playback of audio data and writing into the first area can be performed simultaneously, thereby enabling efficient storage of audio data having a specific length into the first area through a single access to the disk. In addition, when a request for playback is issued, audio data having a specific length of one track are played back instantly, and, furthermore, during playback of the same, the access means accesses the disk, thereby starting writing into the second area of the remaining audio data on the one track; accordingly, time is not consumed from issuance of a request for playback to access to the disk.

According to a disk playback apparatus and a playback method of the invention, when a request for playback is issued, audio data having a specific length of one track are played back instantly, and, furthermore, during playback of the same, access means accesses a disk, thereby starting writing into a second area of the remaining audio data on the one track; accordingly, time is not consumed from issuance of a request for playback to access to the disk.

### BRIEF DESCRIPTION OF THE DRAWINGS

FIG. 1 is a structural block diagram of an optical disk playback apparatus of an embodiment according to the present invention;

FIG. 2 is a view illustrating a format of audio data during storage in a memory of the optical disk playback apparatus of the embodiment according to the invention;

FIG. 3 is a view illustrating a format of compressed audio data during storage in a memory of the optical disk playback apparatus of the embodiment according to the invention;

FIG. 4 is a memory map of audio data and SUBQ data of the embodiment according to the invention;

FIG. 5 is a memory map of a track buffer and a work area of the optical disk playback apparatus of the embodiment according to the invention;

FIG. 6 is a flowchart of processing pertaining to a head search in an optical disk playback apparatus of a first embodiment according to the invention;

FIG. 7 is a flowchart of write processing by a pickup in the optical disk playback apparatus of the first embodiment according to the invention;

FIG. 8 is a flowchart of write processing into a memory in the optical disk playback apparatus of the first embodiment according to the invention;

FIG. 9 is a flowchart of read processing from the memory in the optical disk playback apparatus of the first embodiment according to the invention;

FIG. 10 is a flowchart of head-search processing in the optical disk playback apparatus of the first embodiment according to the invention;

FIG. 11 are schematic diagrams of write processing and read processing in head-search processing in the optical disk playback apparatus of the first embodiment according to the invention;

FIG. 12 are flowcharts of AB repeat processing in an optical disk playback apparatus of a second embodiment according to the invention;

FIG. 13 are schematic diagrams of write processing and read processing during the AB repeat processing in the optical disk playback apparatus of the second embodiment according to the invention;

FIG. 14 is a flowchart of AB repeat processing in an optical disk playback apparatus of a third embodiment according to the invention;

FIG. 15 is a schematic diagram of write processing and read processing during the AB repeat processing in the optical disk playback apparatus of the third embodiment according to the invention; and

FIG. 16 is a flowchart of conventional processing pertaining a head search of a musical selection.

### BEST MODE FOR CARRYING OUT THE INVENTION

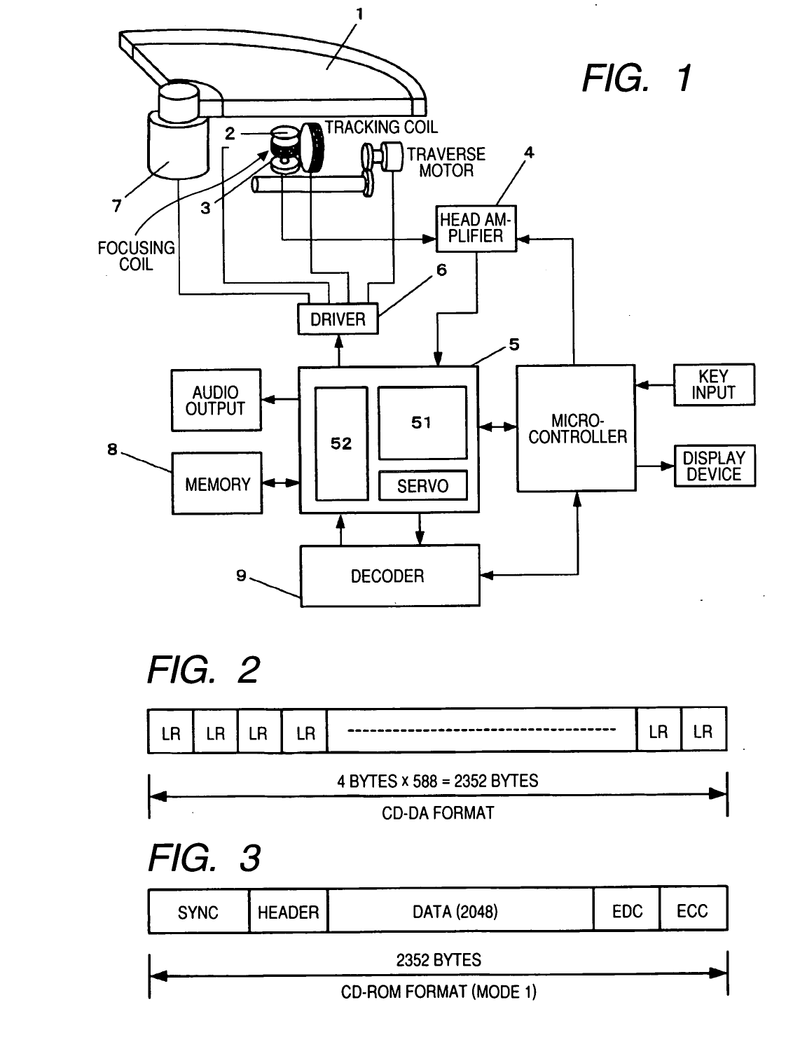

Hereinbelow, optical disk playback apparatuses of embodiments according to the present invention will be described by reference to the drawings. FIG. 1 is a block structural diagram of an optical disk playback apparatus of an embodiment according to the present invention, which is identical in basic configuration to the conventional optical disk playback apparatus.

A point of difference from the conventional optical disk playback apparatus lies in a format for writing into the memory 8. More specifically, as in the conventional optical disk playback apparatus, the signal processing circuit 51 of the servo-and-signal processing LSI 5 demodulates data stored in the optical disk 1; and when, e.g., the optical disk 1 is a CD-DA disk, audio data are stored in the memory 8 in such a format as illustrated in FIG. 2.

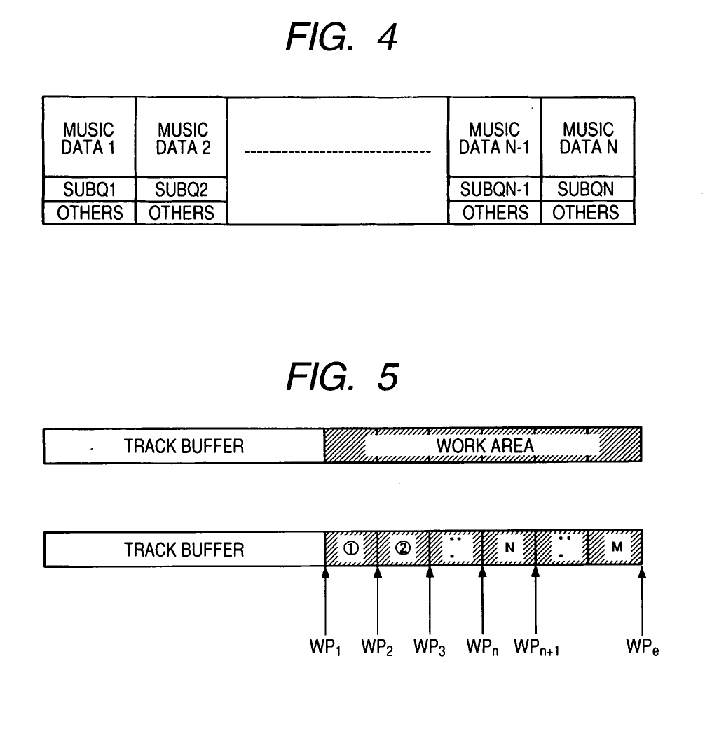

At this time, a point of difference from the conventional apparatus lies in that, as illustrated in FIG. 4, SUBQ data are added to each set of the music data stored in the memory. Similarly, also in the case of a CD-ROM disk, storage in the memory 8 is performed in such a format as illustrated in FIG. 3. Also in this case, SUBQ data are added to each set of the music data to be stored as in the case of a CD-DA.

Physical information pertaining to positions on the optical disk 1 of the music data recorded in the optical disk 1 is recorded in the SUBQ data. More specifically, by means of analyzing the SUBQ data added to the music data, a position where the corresponding audio data are recorded on the optical disk 1 can be determined. Accordingly, when specific audio data are to be searched or output, the optical pickup is moved to a physical position determined through SUBQ data, thereby storing audio data to be output in the memory 8.

### First Embodiment

Hereinbelow, an optical disk playback apparatus of a first embodiment according to the present invention will be described by reference to the drawings. First, FIG. 5 illustrates a map within the memory 8. The memory 8 having the configuration of a ring buffer is divided into an area, called a work area, for storing audio data which have a specific length and which pertain to a plurality of music tracks; and another area, called a track buffer, for storing and outputting remaining audio data of the one track subsequent to the audio data having the specific length.

In processing pertaining to a head search of a music track, essential requirements are that the work area is divided into the number of music tracks recorded in the optical disk 1, and that audio data are stored sequentially in head positions (WPₙ) of the respective divided areas of the music tracks in the work area from the heads of the musical selections. An essential requirement for an amount of audio data to be stored in each of the divided areas of the music track is greater than an amount of data corresponding to a maximum time required for the optical pickup 3 to jump to a target position.

In addition, for preventing writing into the work area beyond the track buffer during writing of audio data into the track buffer, an upper limit (ring buffer MAX) of the ring buffer to be written is set to a boundary (WP₁−1) between the track buffer and the work area.

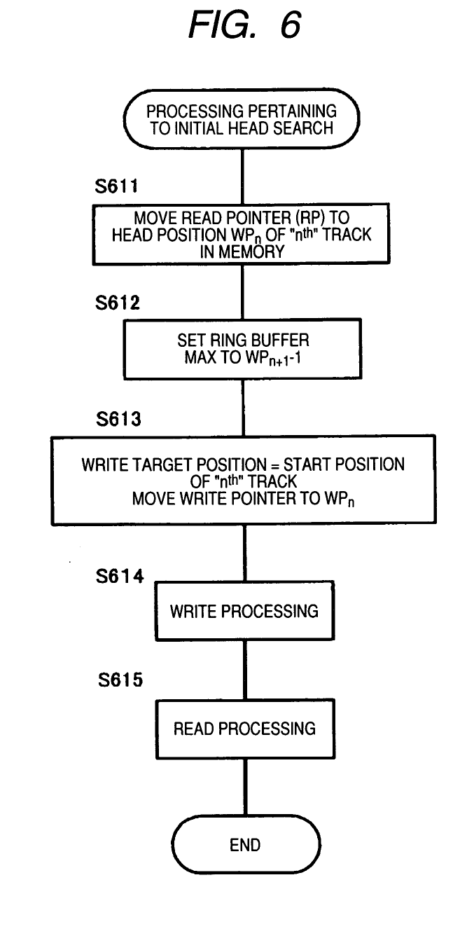

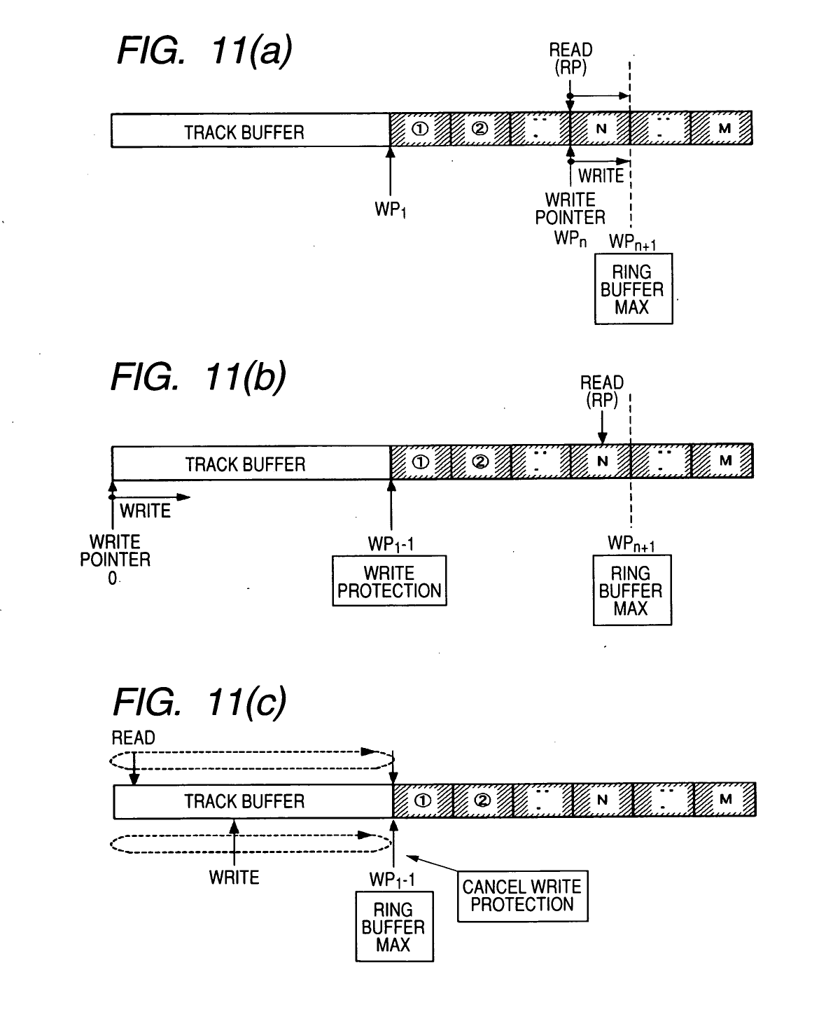

Next, the processing pertaining to head search of a music track will be described by reference to FIGS. 6 and 11. First, in an initial head search; that is, in a head search during which no audio data are stored in a divided area of the work area, a read pointer is moved to a head position (WPₙ) of the divided area (“n^{th}” track) of the work area (step S611). For the purpose of setting a working range of the read pointer to (a range of “n” tracks in the work area+the track buffer), the ring buffer MAX is set to a terminal end (WPₙ₊₁−1) of the “n^{th}” track (step S612). During write processing, the target position to which the optical pickup 3 is to be moved by a jump operation is set to the start position of a music track on the disk, while the write pointer is set to the same position as that of the read position (step S613).

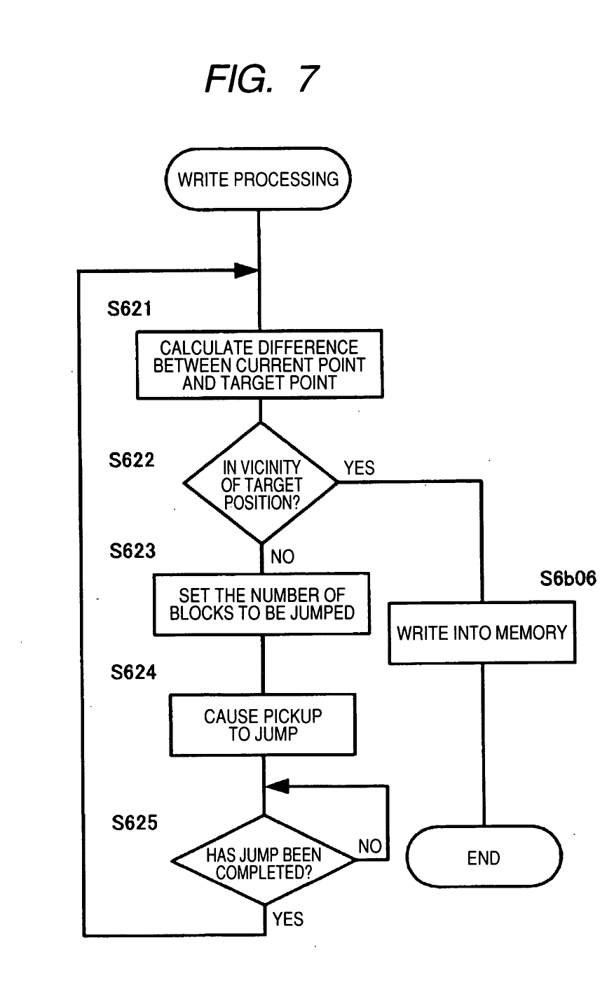

Next, the write processing (S614) is performed as illustrated in the flowchart of FIG. 7. First, a difference between a current position of the optical pickup 3 and the target position where data pertaining to the start of a specific music track on the optical disk 1 are recorded is calculated (step S621). When the difference between the current position and the target position is not “0” the current position is not located several blocks frontward of the target position (step S622), the difference between the two positions is converted into and set to the number of blocks by which the optical pickup 3 is caused to perform jump operation to the target position (step S623). Then, the optical pickup 3 is caused to jump the number of blocks having been set (step S624), and a determination is made as to whether or not the jump operation has been completed (step S625). When the jump is determined to have been completed, a difference between a current position of the optical pickup 3 and the target position on the optical disk 1 is calculated again (step S621). When the difference between the current position and the target position is “0” or when the current position is several blocks frontward of the target position (step S622), SUBQ data pertaining to the target position are confirmed, audio data recorded in the optical disk 1 are extracted by the optical pickup 3, and writing into the memory 8 is started (step S626).

When a predetermined amount of the audio data are stored in the memory 8, audio data written in the memory 8 are output, and playback from the head of the specific music track is started (step S615). FIG. 11(a) illustrates a state of the read pointer and the write pointer within the memory thus far.

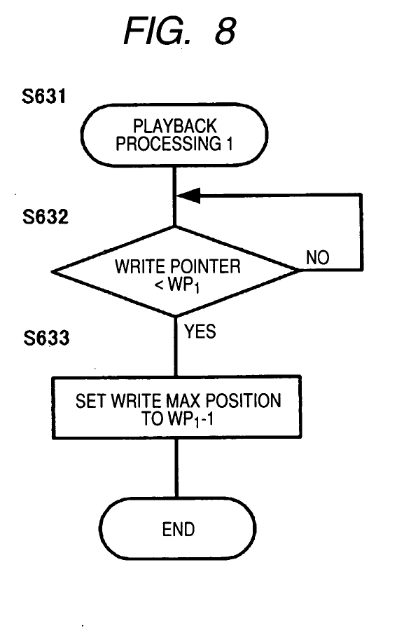

Next, as illustrated in FIG. 8, in playback processing 1, whether or not the write pointer exceeds the ring buffer MAX having been set to the terminal end (WPₙ₊₁−1) of the “n^{th}” track is monitored (step S631). When the write pointer has become greater than the ring buffer MAX (step S632), the write pointer automatically returns to the head of the track buffer in accordance with processing pertaining to the ring buffer (not shown). At this time, since the ring buffer MAX is set to the outside of the track buffer, there are occasions where the write pointer, which has been writing audio data from the audio data the head of the track buffer, writes audio data into the work area beyond the track buffer. For the purpose of preventing writing into the work area beyond the track buffer, a maximum write position (write MAX) is set to a terminal end (WP₁−1) of the track buffer (step S633), thereby protecting from writing into the work area. FIG. 11(b) illustrates a state of the read pointer and the write pointer as described above.

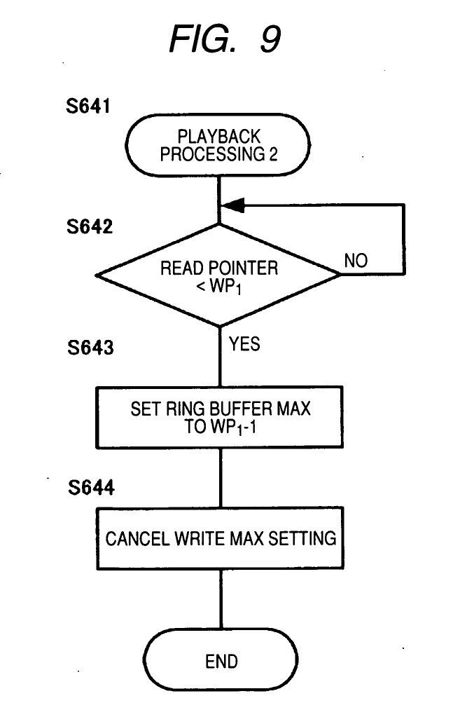

Thereafter, as illustrated in FIG. 9, in playback processing 2, whether or not the read pointer exceeds the ring buffer MAX having been set to the terminal end (WPₙ₊₁−1) of the “n^{th}” track is monitored (step S641). When the write pointer has become greater than the ring buffer MAX, the read pointer automatically returns to the head of the track buffer in accordance with processing (not shown) pertaining to the ring buffer as in the case of the write pointer. At this time, the ring buffer MAX is set to the terminal end (WP₁−1) of the track buffer (step S642). When the ring buffer MAX is changed to the terminal end (WP₁−1) of the track buffer (step S643), since the ring buffer MAX provides the same function as that of the write MAX, the write MAX setting is cancelled (step S644). Then, the write-and-read state which is repeated between the head and the terminal end (WP₁−1) of the track buffer is continued until the music track whose head search has been requested finishes. FIG. 11(c) illustrates such a state of the read pointer and the write pointer as described above.

The above-described operations are terminated when, after a TOC (table of contents) has been read, all the audio data corresponding to the number of songs recorded in the optical disk 1 are stored in the work area by means of playing back a head of a musical selection or performing playback upon selection of a musical selection according to a method for playing back audio data illustrated in FIGS. 6 to 9.

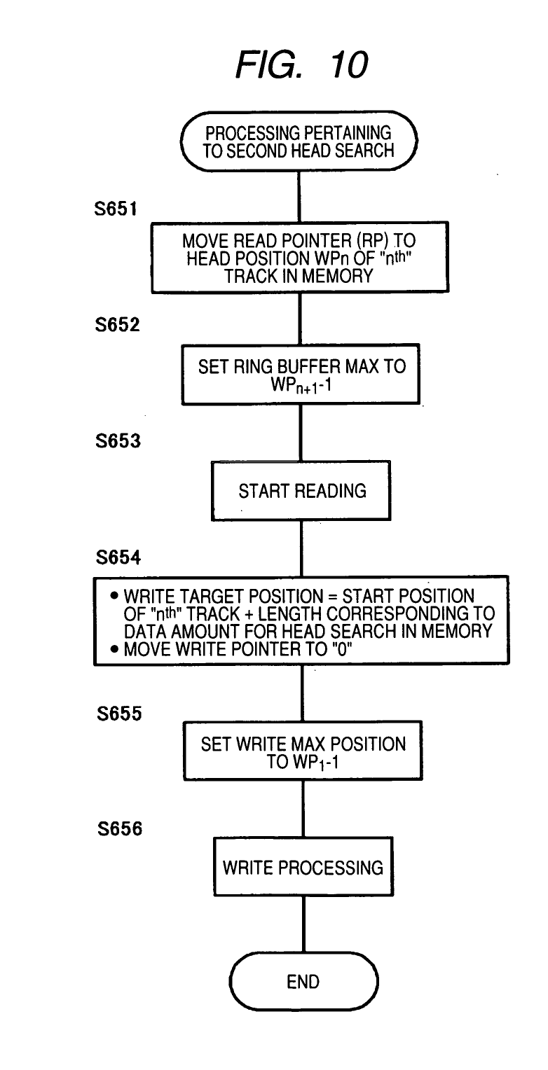

Next, operations of a case where, in a state in which audio data pertaining to the head of a music track are stored in the work area, a request for a head search of a music track is issued through key operation, or the like, will be described by reference to FIG. 10.

First, the read pointer of the memory is stopped so as to stop current sound-playback (not shown). The read pointer is set to the head position (WPₙ) of a divided area (“n^{th}” track) of the work area (step S651). Next, the ring buffer MAX is set to the terminal end (WPₙ₊₁−1) of divided area of the work area (step S652), and reading is started (step S653).

The write pointer is set to the head (0) of the track buffer, and the target position of the optical pickup 3 is set to (the sum of the head position of the “n^{th}” track and a length corresponding to the time of the audio data stored in the work area) (step S654). By means of employing such setting, there can be maintained continuity in audio output at the time when the read pointer has returned from the ring buffer MAX—which has been set to the terminal end of the divided area—to “0”—which is the head of the track buffer. Next, since the position of the write pointer is “0” and the ring buffer is set to the outside of the track buffer, there are occasions where the write pointer, which has been writing audio data from the start of the track buffer, writes audio data in the work area beyond the track buffer. For the purpose of preventing writing into the work area beyond the track buffer, a maximum write position (write MAX) is set to the terminal end (WP₁−1) of the track buffer (step S655), thereby protecting from writing into the work area (FIG. 11(b)). Thereafter, playback processing as illustrated in FIG. 9 is performed in the similar manner as in writing at the initial head search.

When a request for sound-playback from a head of a specific music track is issued in an optical disk playback apparatus as described above, since the optical pickup jumps to a target position during output of audio data from the head of the music track from the work area in the memory, instant head search and playback can be attained while saving time required for the optical pickup to jump. In addition, even after output of audio data in the work area has finished, seamless processing is performed with use of the track buffer and the ring buffer. Accordingly, discontinuous sound does not occur, in contrast to the conventional switching between sound being played back from audio data in a memory, and sound being played back from audio data extracted from an optical disk by the optical pickup; and, in addition, provision of complicated switching means in the optical disk playback apparatus is negated.

### Second Embodiment

Hereinbelow, an optical disk playback apparatus of a second embodiment according to the present invention will be described by reference to the drawings.

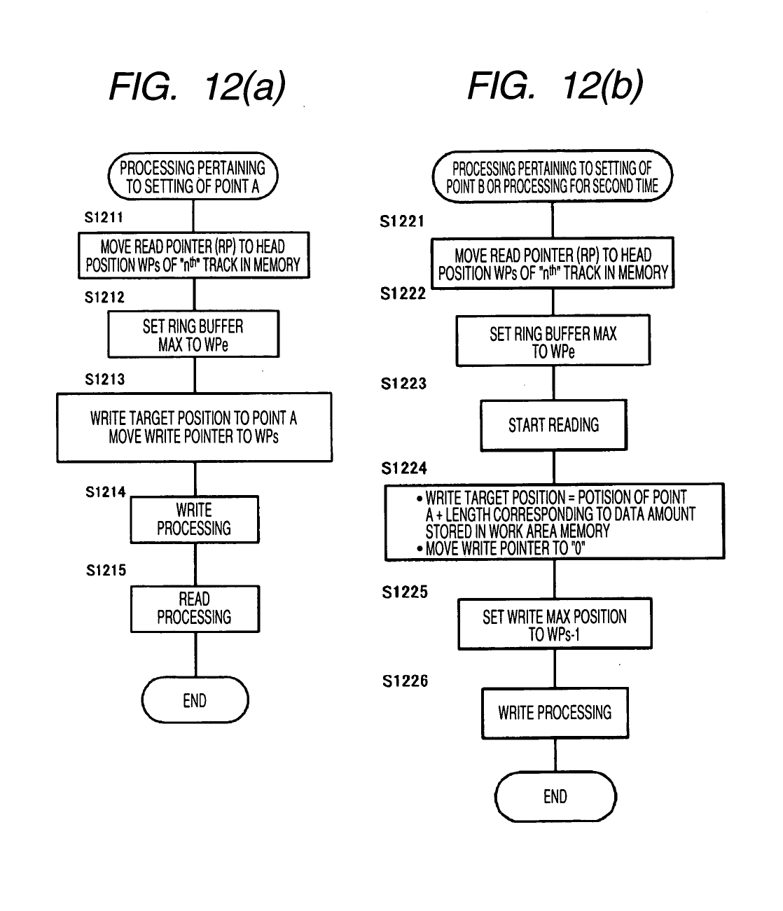

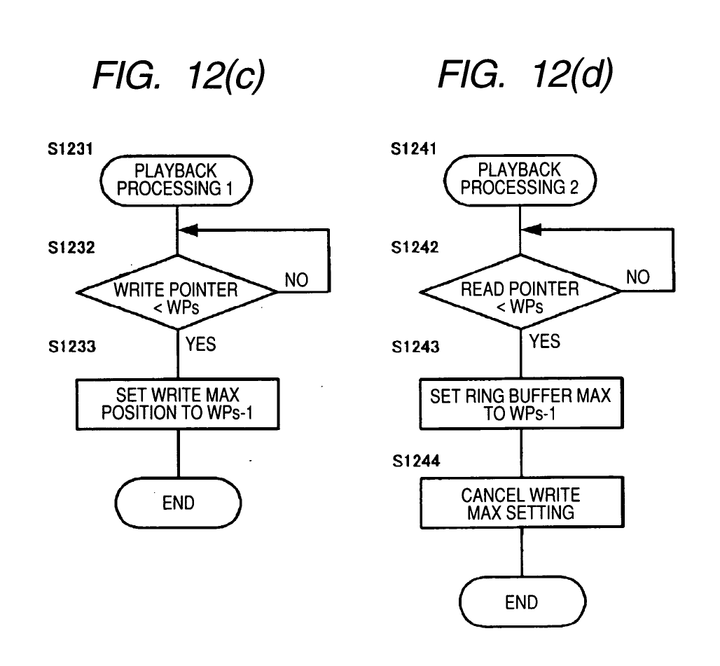

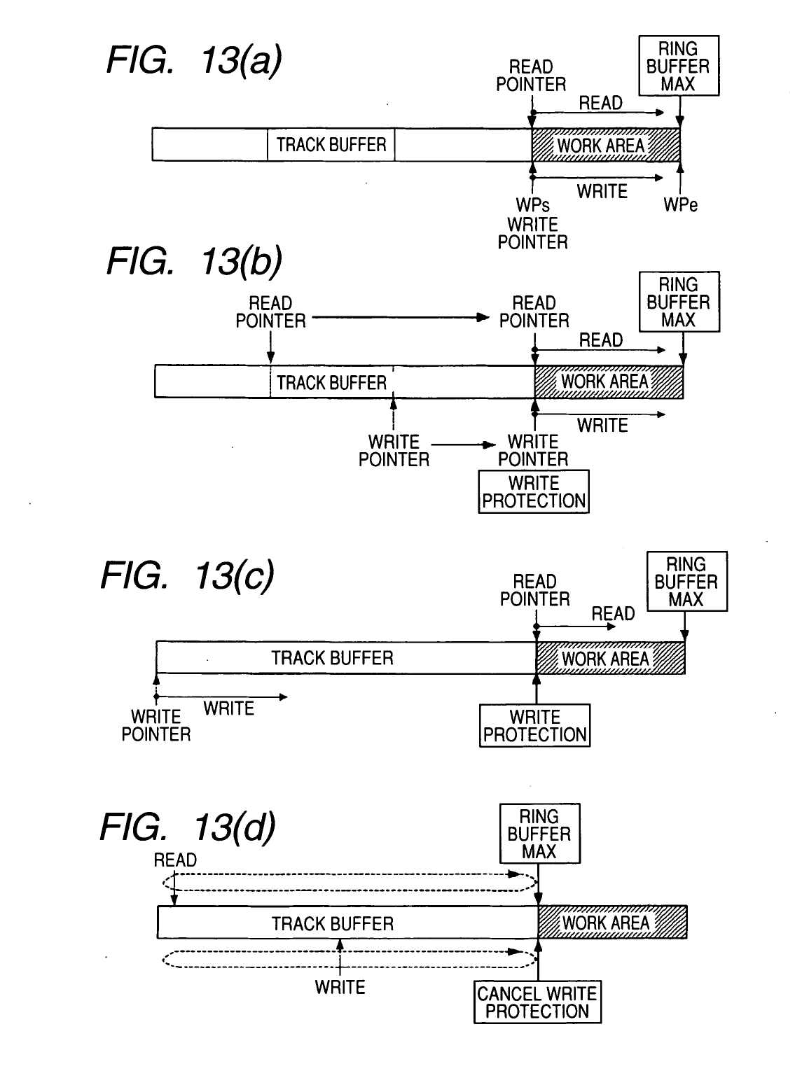

AB repeat processing between two points on a music track will be described by reference to FIGS. 12 and 13.

First, at the time of setting point A, the read pointer is moved to a head position (WPs) of the work area (step S1211). For the purpose of setting a working range of the read pointer to (the work area+the track buffer), the ring buffer MAX is set to the terminal end (WPe) of the work area (step S1212). In write processing, the target position to which the optical pickup 3 is to be moved by a jump operation is set to the position of the point A on the disk, while the write pointer is set to the same position as that of the read position (step S1213).

Next, the write processing (step S1214) is performed as illustrated in the flowchart of FIG. 7. When a predetermined amount of data is stored in the memory 8, output of the audio data written in the memory 8 is started (step S1215). FIG. 13(a) illustrates a state of the read pointer and the write pointer within the memory thus far.

Next, as illustrated in FIG. 12(c), in playback processing 1, whether or not the write pointer exceeds the ring buffer MAX having been set to the terminal end (WPe) of the work area is monitored (step S1231). When the write pointer has become greater than the ring buffer MAX (step S1232), the write pointer automatically returns to the head of the track buffer in accordance with processing (not shown) pertaining to the ring buffer. At this time, since the ring buffer MAX is set to the outside of the track buffer, there are occasions where the write pointer, which has been writing audio data from the head of the track buffer, writes audio data into the work area beyond the track buffer. For the purpose of preventing writing into the work area beyond the track buffer, a maximum write position (write MAX) is set to a terminal end (WPs−1) of the track buffer (step S1233), thereby protecting from writing into the work area. FIG. 13(b) illustrates a state of the read pointer and the write pointer as described above.

Thereafter, as illustrated in FIG. 12(d), in playback processing 2, whether or not the read pointer exceeds the ring buffer MAX having been set to the terminal end (WPe) of the work area is monitored (step S1241). When the write pointer has become greater than the ring buffer MAX, as does the write pointer (step S1242), the read pointer automatically returns to the head of the track buffer in accordance with processing (not shown) pertaining to the ring buffer. In this case, the ring buffer MAX is set to the terminal end (WPs−1) of the track buffer (step S1243). When the ring buffer MAX is changed to the terminal end (WPs−1) of the track buffer, since the ring buffer MAX provides the same function as that of the write MAX, the write MAX setting is cancelled (step S1244). Then, the write-and-read state repeated between the head and the terminal end (WPs−1) of the track buffer is continued until completion of playback of audio data between the points A and B. FIG. 13(d) illustrates a state of the read pointer and the write pointer as described above.

Next, AB repeat processing of a case where the point B has been set or where a request for a second playback operation from the point A is issued will be described by reference to FIG. 12(b). First, the read pointer in the memory is stopped so as to stop a current sound-play (not shown). The read pointer is set to the head position (WPs) of the work area (step S1221). Next, the ring buffer MAX is set to the terminal end (WPe) of the work area (step S1212), and reading is started (step S1223).

The write pointer is set to the head (0) of the track buffer, and a target position of the optical pickup 3 is set to (the position of the point A +length corresponding to the audio data stored in the work area) (step S1224). By means of employing such setting, there can be maintained continuity in audio output at the time when the read pointer has returned from the ring buffer MAX—which has been set to the terminal end of the work area—to “0”—which is the head of the track buffer. Next, since a write position is set to “0” and the ring buffer is set to the outside of the track buffer, there are occasions where the write pointer, which has been writing audio data from the head of the track buffer, writes audio data into the work area beyond the track buffer. For the purpose of preventing writing into the work area beyond the track buffer, a maximum write position (write MAX) is set to the terminal end (WPs−1) of the track buffer (step S1225), thereby protecting from writing into the work area (FIG. 13(c)). Then, write processing illustrated in FIG. 7 is performed as in the case of the initial writing.

Thereafter, playback processing as illustrated in FIG. 12(d) is performed as in the case of the initial writing, and the write-and-read state repeated between the head and the terminal end (WPs−1) of the track buffer is continued until completion of playback of audio data between A and B.

In the optical disk playback apparatus as described above, even when a request for sound-playback of data from an arbitrary position as in AB repeat mode is issued, the optical pickup jumps to the target position during output of audio data from the point A on the music track from the work area in the memory; accordingly, instant playback from an arbitrary position can be attained while saving time required for the optical pickup to jump. In addition, even after completion of output of audio data in the work area, seamless processing is performed with use of the track buffer and the ring buffer. Accordingly, discontinuous sound does not occur, in contrast to the conventional switching between sound being played back from audio data in a memory, and sound being played back from audio data extracted from an optical disk by the optical pickup; and, in addition, provision of complicated switching means in the optical disk playback apparatus is negated.

### Third Embodiment

Hereinbelow, an optical disk playback apparatus of a third embodiment according to the present invention will be described by reference to the drawings.

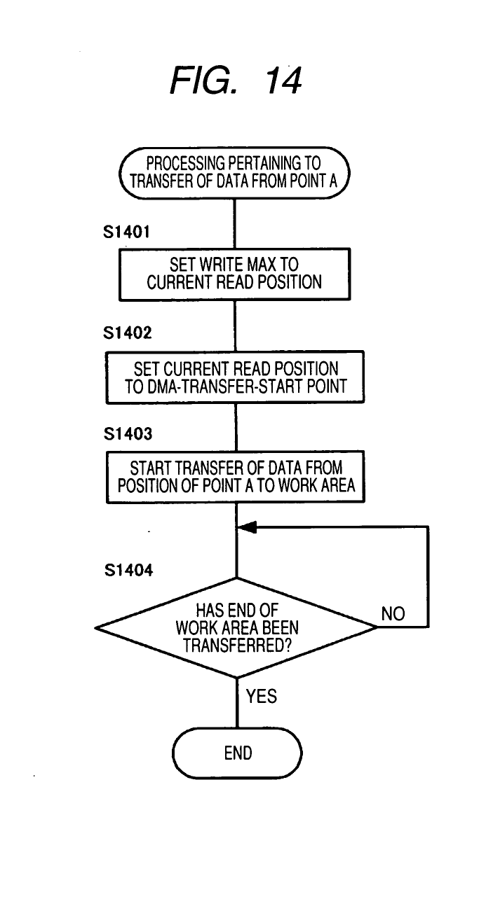

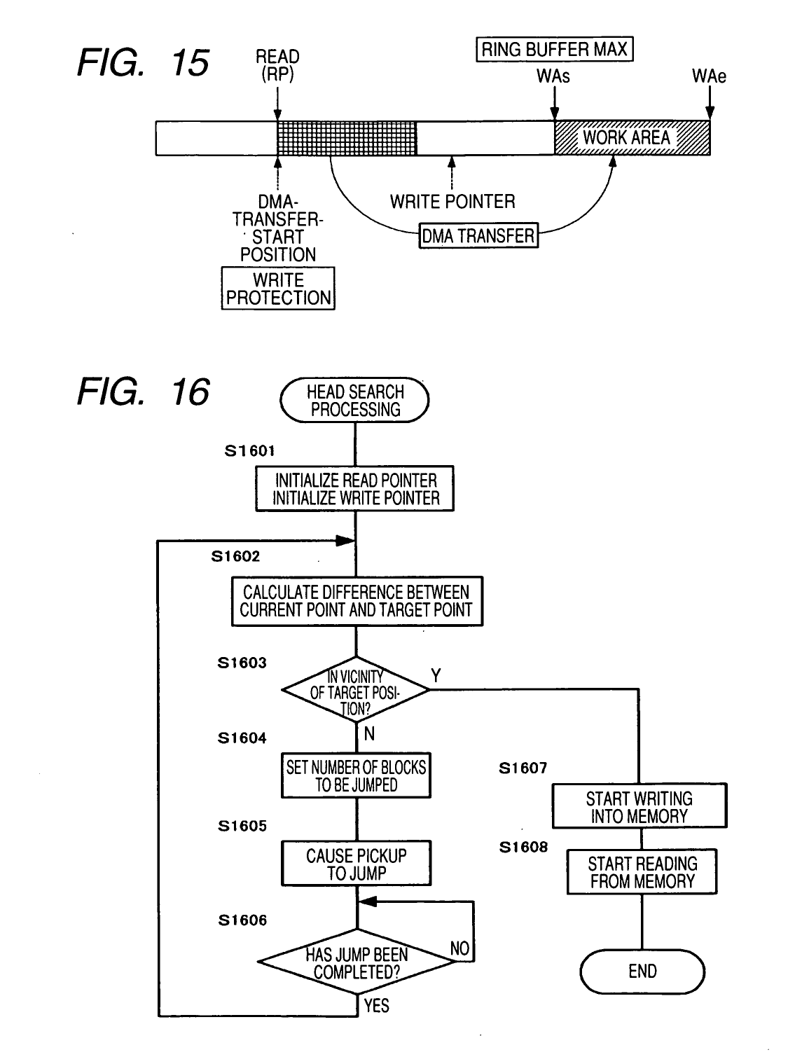

When a request for setting of a point A is issued during playback of audio data, audio data stored in the track buffer are transferred to the work area through DMA (direct memory access) transfer. In this case, as illustrated in FIG. 14, the write MAX is set to a current read position so that the audio data stored in the track buffer are not overwritten by audio data to be newly written in the track buffer (S1401). Next, the current read position is set to a DMA-transfer-start position (S1402). DMA transfer is started (S1403). When transfer of the audio data has come to the terminal end of the work area, transfer is terminated (S1404). FIG. 15 illustrates a state of the read pointer and the write pointer during this processing.

1. A disk playback apparatus having access means for accessing a disk, and access-control means for controlling said access means to an arbitrary position on said disk, comprising:
storage means divided into a first area for storing at least a set of audio data having a specific length for at least one track, and a second area for storing remaining audio data for said one track;
write means which accesses said disk, thereby writing into said first area said audio data having said specific length and whose start point is an arbitrary position on said one track, and writing said remaining audio data into said second area during playback of said audio data having said specific length; and
read means for reading said audio data having said specific length and said remaining audio data continuously.

2. The disk playback apparatus defined in claim 1, further comprising transfer means for transferring to said first area audio data from a read point of said second area, wherein
said write means writes, during playback of said remaining audio data, said audio data from said read point having been transferred by said transfer means into said first area, and said remaining audio data of said one track of said audio data from said read point having been written into said first area in said second area; and
said read means reads audio data from said read point having been written into said first area and said remaining audio data of said one track of said audio data from said read point having been written into said second area continuously.

3. A disk playback method for a disk playback apparatus which accesses a disk, thereby storing audio data having a specific length and whose start point is an arbitrary position into a first area in advance, and playing back said audio data stored in said storage means, comprising steps of:
reading said audio data having said specific length and whose start point is said arbitrary position on said one track;
during reading of said audio data having said specific length, accessing said disk, thereby starting writing of remaining audio data on said one track into a second area of said storage means; and
reading said remaining audio data continuously subsequent to said audio data having said specific length.

4. The disk playback method defined in claim 3, further comprising steps of:
during reading of said remaining audio data, transferring audio data from said read point in said second area to said first area;
writing said audio data from said read point having been transferred into said first area;
reading said audio data from said read point having been written into said first area;
during reading of said audio data from said read point, accessing said disk, thereby beginning to write into said second area of remaining said audio data on said one track of said audio data from said read point having been written into said first area in said second area; and
reading said remaining audio data of said one track of said audio data from said read point in said second area continuously subsequent to said audio data from said read point in said first area.
